(19) United States
(12) Patent Application Publication
(10) Pub. No.: US 2026/0085926 A1
(43) Pub. Date: Mar. 26, 2026

(54) DUAL-BASELINE DEPTH SENSING SYSTEM AND METHOD BASED ON STRUCTURED LIGHT

(71) Applicant: HIMAX TECHNOLOGIES LIMITED, Tainan City (TW)

(72) Inventors: Wu-Feng CHEN, Tainan City (TW); Hsueh-Tsung LU, Tainan City (TW)

(21) Appl. No.: 18/892,526

(22) Filed: Sep. 22, 2024

(51) Int. Cl. G01B 11/22; G06T 7/521

(52) U.S. Cl. CPC G01B 11/22; G06T 7/521; G06T 2207/10016

(57) ABSTRACT

A dual-baseline depth sensing system based on structured light includes a structured light projector, a polarized beam splitter (PBS), a phase retardation mirror, a first reflective mirror, a second reflective mirror, and a structured light sensor. The structured light projector projects a p-wave light or a s-wave light. The PBS transmits the p-wave light and reflects the s-wave light. The phase retardation mirror reflects the transmitted p-wave light to form a reverse s-wave light. The reverse s-wave is then reflected by the PBS. The first reflective mirror reflects the reflected reverse s-wave light to form a first structured light projected on an object. The second reflective mirror reflects the reflected s-wave light to form a second structured light projected on the object. The structured light sensor receives reflections from the object and correspondingly generates video data.

### BACKGROUND

### Field of Invention

The present disclosure relates to depth sensing. More particularly, the present disclosure relates to a dual-baseline depth sensing system based on structured light.

### Description of Related Art

In the process of depth sensing, a baseline between a sensor and a projected structured light is used. In this process, as the baseline is narrower, a depth resolution is lower. Therefore, if the higher depth resolution is desired, the baseline can be designed to be wider. However, as the baseline is wider, the light spots are easier to be blocked or a close-range blind area is easier to occur.

### SUMMARY

The present disclosure provides a dual-baseline depth sensing system based on structured light. The system includes a structured light projector, a polarized beam splitter (PBS), a phase retardation mirror, a first reflective mirror, a second reflective mirror, and a structured light sensor. The structured light projector projects a p-wave light or a s-wave light in a first direction. The PBS transmits the p-wave light and reflects the s-wave light. The phase retardation mirror reflects the transmitted p-wave light to form a reverse s-wave light. The reverse s-wave light is directed toward a second direction opposite to the first direction. The reverse s-wave is then reflected by the PBS. The reflected reverse s-wave light is directed toward a third direction perpendicular to the first direction. The first reflective mirror reflects the reflected reverse s-wave light to form a first structured light projected on an object in the first direction. The second reflective mirror reflects the reflected s-wave light to form a second structured light projected on the object in the first direction. The reflected s-wave light is directed toward a fourth direction opposite to the third direction. The structured light sensor receives reflections from the object and correspondingly generates video data.

In accordance with one or more embodiments of the present disclosure, the structured light projector projects the p-wave light in a first frame and projects the s-wave light in a second frame subsequent to the first frame.

In accordance with one or more embodiments of the present disclosure, the system further includes a structured light depth processor to receive the video data and generate structured light depth information according to the video data. The structured light depth information generated in the first frame corresponds to the first structured light and includes a first depth corresponding to a specific pixel of a dot image corresponding to the video data. The structured light depth information generated in the second frame corresponds to the second structured light and includes a second depth corresponding to the specific pixel.

In accordance with one or more embodiments of the present disclosure, the structured light depth processor compares the first depth with a threshold to outputs a determined depth of the specific pixel.

In accordance with one or more embodiments of the present disclosure, when the first depth is less than or equal to the threshold or the second depth is 0, the structured light depth processor outputs the determined depth as the first depth.

In accordance with one or more embodiments of the present disclosure, when the first depth is greater than the threshold and the second depth is greater than 0, the structured light depth processor outputs the determined depth as the second depth.

In accordance with one or more embodiments of the present disclosure, when the first depth is greater than the threshold and the second depth is 0, the structured light depth processor outputs the determined depth as the first depth.

In accordance with one or more embodiments of the present disclosure, the first reflective mirror is closer to the structured light sensor than the second reflective mirror.

In accordance with one or more embodiments of the present disclosure, a baseline between the structured light sensor and the first structured light is less than a baseline between the structured light sensor and the second structured light.

In accordance with one or more embodiments of the present disclosure, the phase retardation mirror is a half-wave plate that converts the transmitted p-wave light into the reverse s-wave light.

In accordance with one or more embodiments of the present disclosure, the structured light projector includes a Liquid Crystal on Silicon (LCOS) element or a LC lens element.

The present disclosure further provides a dual-baseline depth sensing method based on structured light. The method includes: projecting a p-wave light or a s-wave light in a first direction; utilizing a PBS to transmit the p-wave light and reflect the s-wave light; utilizing a phase retardation mirror to reflect the transmitted p-wave light to form a reverse s-wave light, in which the reverse s-wave light is directed toward a second direction opposite to the first direction; utilizing the PBS to reflect the reverse s-wave, in which the reflected reverse s-wave light is directed toward a third direction perpendicular to the first direction; utilizing a first reflective mirror to reflect the reflected reverse s-wave light to form a first structured light projected on an object in the first direction; utilizing a second reflective mirror to reflect the reflected s-wave light to form a second structured light projected on the object in the first direction; in which the reflected s-wave light is directed toward a fourth direction opposite to the third direction; and utilizing a structured light sensor receives reflections from the object and correspondingly generates video data.

In accordance with one or more embodiments of the present disclosure, the p-wave light is projected in a first frame and the s-wave light is projected in a second frame subsequent to the first frame.

In accordance with one or more embodiments of the present disclosure, the method further includes: utilizing a structured light depth processor to receive the video data and generate structured light depth information according to the video data. The structured light depth information generated in the first frame corresponds to the first structured light and includes a first depth corresponding to a specific pixel of a dot image corresponding to the video data. The structured light depth information generated in the second frame corresponds to the second structured light and includes a second depth corresponding to the specific pixel.

In accordance with one or more embodiments of the present disclosure, the structured light depth processor compares the first depth with a threshold to output a determined depth of the specific pixel.

In accordance with one or more embodiments of the present disclosure, when the first depth is less than or equal to the threshold or the second depth is 0, the structured light depth processor outputs the determined depth as the first depth.

In accordance with one or more embodiments of the present disclosure, when the first depth is greater than the threshold and the second depth is greater than 0, the structured light depth processor outputs the determined depth as the second depth.

In accordance with one or more embodiments of the present disclosure, when the first depth is greater than the threshold and the second depth is 0, the structured light depth processor outputs the determined depth as the first depth.

In accordance with one or more embodiments of the present disclosure, the first reflective mirror is closer to the structured light sensor than the second reflective mirror.

In accordance with one or more embodiments of the present disclosure, a baseline between the structured light sensor and the first structured light is less than a baseline between the structured light sensor and the second structured light.

In order to let above mention of the present disclosure and other objects, features, advantages, and embodiments of the present disclosure to be more easily understood, the description of the accompanying drawing as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows a block diagram illustrating a dual-baseline depth sensing system according to some embodiments of the present disclosure.

FIG. 2 shows a block diagram illustrating the dual-baseline depth sensing system according to some embodiments of the present disclosure.

FIG. 3 shows a dual-baseline depth sensing method corresponding to the dual-baseline depth sensing system according to some embodiments of the present disclosure.

### DETAILED DESCRIPTION

Specific embodiments of the present disclosure are further described in detail below with reference to the accompanying drawings, however, the embodiments described are not intended to limit the present disclosure and it is not intended for the description of operation to limit the order of implementation. The terms “first” and “second” used in the specification should be understood for identifying units or data described by the same terminology, but are not referred to a particular order or sequence.

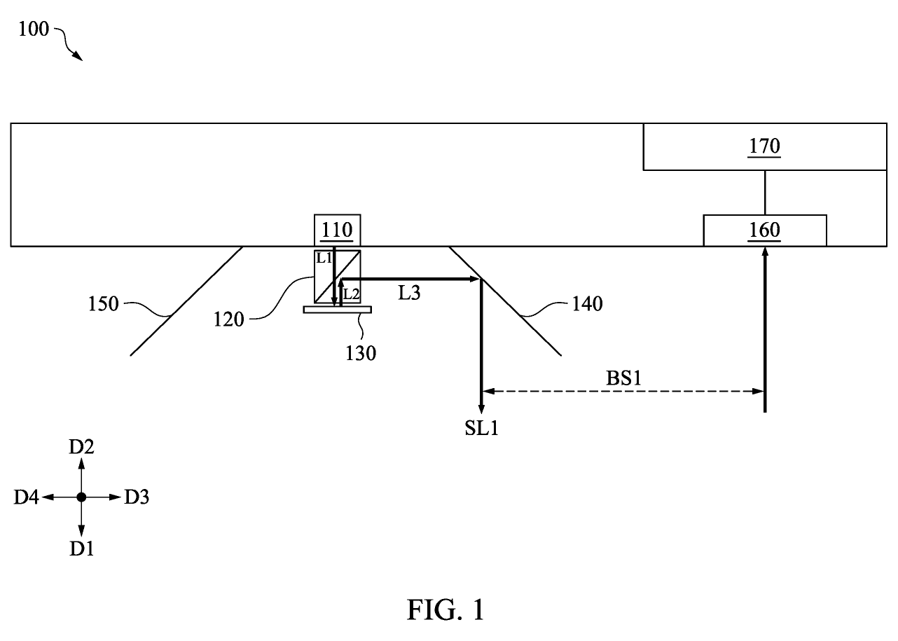

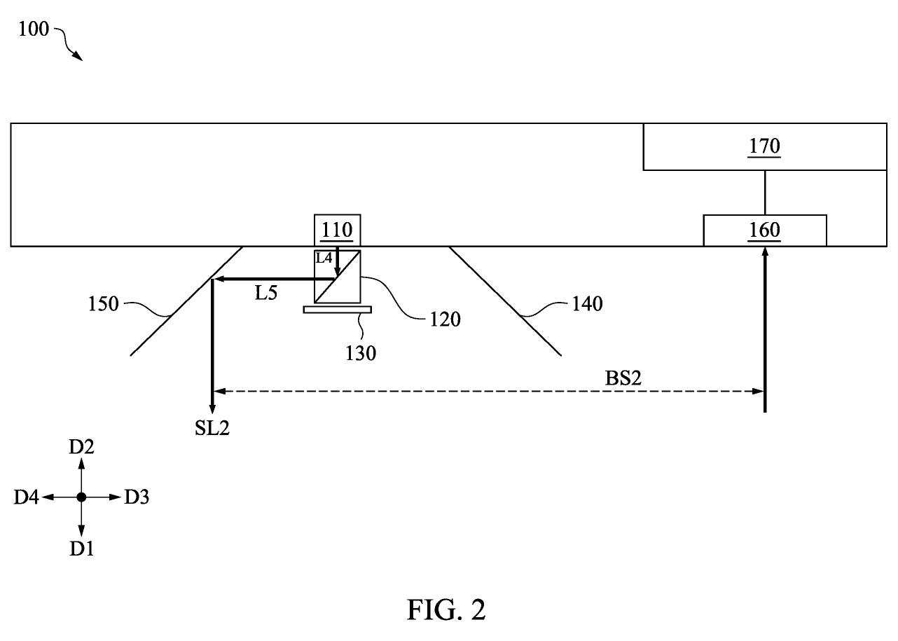

Each of FIG. 1 and FIG. 2 shows a block diagram illustrating a dual-baseline depth sensing system 100 according to some embodiments of the present disclosure. The dual-baseline depth sensing system 100 includes a structured light projector 110, a polarized beam splitter (PBS) 120, a phase retardation mirror 130, two reflective mirrors 140 and 150, a structured light sensor 160, and a structured light depth processor 170.

The structured light projector 110 projects a structured light in a direction D1, and the structured light is one of a p-wave light and a s-wave light. Specifically, the structured light projector 110 is a controllable light source to be controlled to project the p-wave light in i^{th} frame, project the s-wave light in (i+1)^{th} frame subsequent to the i^{th} frame, and project the p-wave light in (i+2)^{th} frame, and so on, where i is a positive integer. In other words, the structured light projector 110 projects the p-wave light and the s-wave sequentially.

In some embodiment of the present disclosure, the structured light projector 110 may include a laser light module and a diffractive optical element (DOE) so as to project a structured light, but the present disclosure is not limited thereto. In some embodiment of the present disclosure, the structured light projector 110 includes a Liquid Crystal on Silicon (LCOS) element or a LC lens element, such that the structured light projector 110 is controlled to project the p-wave light or the s-wave light.

The PBS 120 is an optical element that transmits the p-wave light and reflects the s-wave light. The phase retardation mirror 130 is an optical element that alters the polarization state of a light wave travelling through it. In some embodiment of the present disclosure, the phase retardation mirror 130 is a half-wave plate that converts the p-wave light into the s-wave light. As shown in FIG.1 and FIG. 2, the reflective mirror 140 is closer to the structured light sensor 160 than the reflective mirror 150.

As shown in FIG. 1, when the structured light projector 110 projects the p-wave light L1 in the direction D1, the PBS 120 transmits the p-wave light L1. Then, the phase retardation mirror 130 reflects the transmitted p-wave light L1 to form a reverse s-wave light L2. It is noted that the phase retardation mirror 130 converts the transmitted p-wave light L1 into the reverse s-wave light L2. The reverse s-wave light L2 is directed toward a direction D2 opposite to the direction D1. Then, the reverse s-wave L2 is reflected by the PBS 120, and the reflected reverse s-wave light L3 is directed toward a direction D3. Then, the reflective mirror 140 reflects the reflected reverse s-wave light L3 to form a structured light SL1 to be projected on an object (not shown) in the direction D1.

As shown in FIG. 2, when the structured light projector 110 projects the s-wave light L4 in the direction D1, the PBS 120 reflects the s-wave light L4. The reflected s-wave light L5 is directed toward a direction D4 opposite to the direction D3, in which the direction D4 is perpendicular to the direction D1. Then, the reflective mirror 150 reflects the reflected s-wave light L5 to form a structured light SL2 to be projected on the object (not shown) in the direction D1.

As shown in FIG. 1 and FIG. 2, the structured light sensor 160 receives reflections from the object and correspondingly generates video data. Specifically, the structured light sensor 160 adopts a structured light technique to resolve distance (or depth) between the structured light sensor 160 and the object for each pixel of a captured image (called as a dot image in below description). The structured light sensor 160 may be a charge-coupled device (CCD) sensor, a complementary metal-oxide semiconductor (CMOS) sensor, or any other sensor configured to detect reflections of a target surface of the object.

The structured light depth processor 170 is coupled to the structured light sensor 160 to receive the video data from the structured light sensor 160 and then generate structured light depth information according to the video data. The structured light depth processor 170 may be implemented and executed by hardware (e.g., digital image processor), software, or a combination thereof.

When the structured light projector 110 projects the p-wave light L1 as shown in FIG. 1, the structured light depth information generated by the structured light depth processor 170 in the i^{th} frame corresponds to the structured light SL1 and includes a first depth corresponding to a specific pixel of a dot image corresponding to the video data.

When the structured light projector 110 projects the s-wave light L4 as shown in FIG. 2, the structured light depth information generated by the structured light depth processor 170 in the (i+1)^{th} frame corresponds to the structured light SL2 and includes a second depth corresponding to the specific pixel of the dot image corresponding to the video data.

As shown in FIG. 1, a baseline (distance) between the structured light sensor 160 and the projected structured light SL1 is labelled as “BS1”. As shown in FIG. 2, a baseline (distance) between the structured light sensor 160 and the projected structured light SL2 is labelled as “BS2”. Therefore, the present disclosure relates to the “dual-baseline” depth sensing system 100.

As shown in FIG. 1 and FIG. 2, the baseline BS1 is less than the baseline BS2. Therefore, it could be understood that the depth resolution of the structured light depth information corresponding to the structured light SL1 is lower than the depth resolution of the structured light depth information corresponding to the structured light SL2. However, the structured light depth information corresponding to the structured light SL2 may be inaccurate (e.g., because the light spots are blocked or a close-range blind area occurs) when the depth between the structured light sensor 160 and the surface of the object is closer. Accordingly, after the structured light depth processor 170 generated the structured light depth information in the (i+1)^{th} frame, the structured light depth processor 170 compares the first depth with a threshold to output a determined depth of the specific pixel so as to complete all depths of total pixels of the dot image, thereby improving the accuracy of depth sensing. Specifically, the present disclosure can achieve high decode rate with respect to depth sensing. The threshold is designed according to actual need, such as 80 cm or the like, but the present disclosure is not limited thereto. The determined depth of the specific pixel is obtained by the following manner.

When the first depth is less than or equal to the threshold or the second depth is 0, the structured light depth processor 170 outputs the determined depth as the first depth. When the first depth is greater than the threshold and the second depth is greater than 0, the structured light depth processor 170 outputs the determined depth as the second depth. When the first depth is greater than the threshold and the second depth is 0, the structured light depth processor 170 outputs the determined depth as the first depth. The structured light depth processor 170 outputs the optimal structured light depth information (including the determined depth) according to the aforementioned manner.

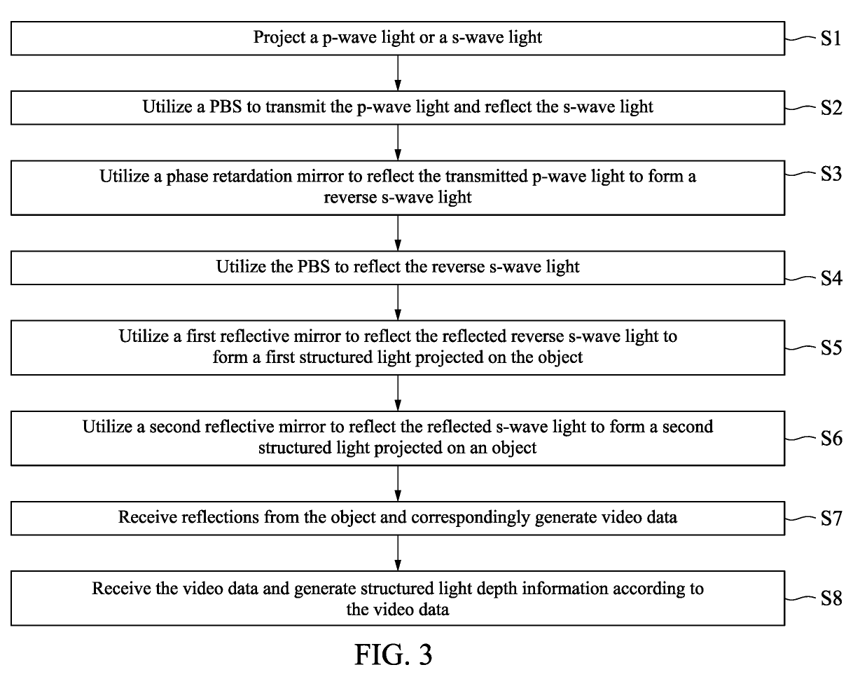

FIG. 3 shows a dual-baseline depth sensing method corresponding to the dual-baseline depth sensing system 100 according to some embodiments of the present disclosure. In Step S1, the structured light projector 110 projects the p-wave light L1 or the s-wave light L4. In Step S2, the PBS 120 transmits the p-wave light L1 and reflects the s-wave light L4. In Step S3, the phase retardation mirror 130 reflects the transmitted p-wave light L1 to form the reverse s-wave light L2. In Step S4, the PBS 120 reflects the reverse s-wave L2. In Step S5, the reflective mirror 140 reflects the reflected reverse s-wave light L3 to form the structured light SL1 to be projected on the object. In Step S6, the reflective mirror 150 reflects the reflected s-wave light L5 to form the structured light SL2 to be projected on the object. In Step S7, the structured light sensor 160 receives reflections from the object and correspondingly generates video data. In Step S8, the structured light depth processor 170 receives the video data and generates structured light depth information according to the video data.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A dual-baseline depth sensing system based on structured light, comprising:
a structured light projector configured to project a p-wave light or a s-wave light in a first direction;
a polarized beam splitter (PBS) configured to transmit the p-wave light and reflect the s-wave light;
a phase retardation mirror configured to reflect the transmitted p-wave light to form a reverse s-wave light, wherein the reverse s-wave light is directed toward a second direction opposite to the first direction, wherein the reverse s-wave is then reflected by the PBS, wherein the reflected reverse s-wave light is directed toward a third direction perpendicular to the first direction;
a first reflective mirror configured to reflect the reflected reverse s-wave light to form a first structured light projected on an object in the first direction;
a second reflective mirror configured to reflect the reflected s-wave light to form a second structured light projected on the object in the first direction, wherein the reflected s-wave light is directed toward a fourth direction opposite to the third direction; and
a structured light sensor configured to receive reflections from the object and correspondingly generate video data.

2. The system of claim 1, wherein the structured light projector projects the p-wave light in a first frame and projects the s-wave light in a second frame subsequent to the first frame.

3. The system of claim 2, further comprising:
a structured light depth processor configured to receive the video data and generate structured light depth information according to the video data;
wherein the structured light depth information generated in the first frame corresponds to the first structured light and includes a first depth corresponding to a specific pixel of a dot image corresponding to the video data; and
wherein the structured light depth information generated in the second frame corresponds to the second structured light and includes a second depth corresponding to the specific pixel.

4. The system of claim 3, wherein the structured light depth processor compares the first depth with a threshold to output a determined depth of the specific pixel.

5. The system of claim 4, wherein when the first depth is less than or equal to the threshold or the second depth is 0, the structured light depth processor outputs the determined depth as the first depth.

6. The system of claim 4, wherein when the first depth is greater than the threshold and the second depth is greater than 0, the structured light depth processor outputs the determined depth as the second depth.

7. The system of claim 4, wherein when the first depth is greater than the threshold and the second depth is 0, the structured light depth processor outputs the determined depth as the first depth.

8. The system of claim 1, wherein the first reflective mirror is closer to the structured light sensor than the second reflective mirror.

9. The system of claim 1, wherein a baseline between the structured light sensor and the first structured light is less than a baseline between the structured light sensor and the second structured light.

10. The system of claim 1, wherein the phase retardation mirror is a half-wave plate that converts the transmitted p-wave light into the reverse s-wave light.

11. The system of claim 1, wherein the structured light projector includes a Liquid Crystal on Silicon (LCOS) element or a LC lens element.

12. A dual-baseline depth sensing method based on structured light, comprising:
projecting a p-wave light or a s-wave light in a first direction;
utilizing a PBS to transmit the p-wave light and reflect the s-wave light;
utilizing a phase retardation mirror to reflect the transmitted p-wave light to form a reverse s-wave light, wherein the reverse s-wave light is directed toward a second direction opposite to the first direction;
utilizing the PBS to reflect the reverse s-wave, wherein the reflected reverse s-wave light is directed toward a third direction perpendicular to the first direction;
utilizing a first reflective mirror to reflect the reflected reverse s-wave light to form a first structured light projected on an object in the first direction;
utilizing a second reflective mirror to reflect the reflected s-wave light to form a second structured light projected on the object in the first direction; wherein the reflected s-wave light is directed toward a fourth direction opposite to the third direction; and
utilizing a structured light sensor to receive reflections from the object and correspondingly generate video data.

13. The method of claim 12, wherein the p-wave light is projected in a first frame and the s-wave light is projected in a second frame subsequent to the first frame.

14. The method of claim 13, further comprising:
utilizing a structured light depth processor to receive the video data and generate structured light depth information according to the video data;
wherein the structured light depth information generated in the first frame corresponds to the first structured light and includes a first depth corresponding to a specific pixel of a dot image corresponding to the video data; and
wherein the structured light depth information generated in the second frame corresponds to the second structured light and includes a second depth corresponding to the specific pixel.

15. The method of claim 14, wherein the structured light depth processor compares the first depth with a threshold to output a determined depth of the specific pixel.

16. The method of claim 15, wherein when the first depth is less than or equal to the threshold or the second depth is 0, the structured light depth processor outputs the determined depth as the first depth.

17. The method of claim 15, wherein when the first depth is greater than the threshold and the second depth is greater than 0, the structured light depth processor outputs the determined depth as the second depth.

18. The method of claim 15, wherein when the first depth is greater than the threshold and the second depth is 0, the structured light depth processor outputs the determined depth as the first depth.

19. The method of claim 12, wherein the first reflective mirror is closer to the structured light sensor than the second reflective mirror.

20. The method of claim 12, wherein a baseline between the structured light sensor and the first structured light is less than a baseline between the structured light sensor and the second structured light.
